(19) United States
(12) Patent Application Publication
(10) Pub. No.: US 2004/0240829 A1
(43) Pub. Date: Dec. 2, 2004

(54) Channeling for use with light fiber

(75) Inventors: Jennifer J. Sahlin, Minneapolis, MN (US); Steven R. Vanhoose, Stillwater, MN (US); Kenneth D. Wanned, Hugo, MN (US); Stephen M. Randall, North St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/889,720

(22) Filed: Jul. 13, 2004

Related U.S. Application Data
(62) Division of application No. 09/969,272, filed on Oct. 1, 2001.

(51) Int. Cl. G02B 6/00

(52) U.S. Cl. 385/136

(57) ABSTRACT

A support channel for a light fiber includes a fiber support member designed to partially circumscribe a light fiber, first and second legs, and first and second feet at the ends of the first and second legs. The fiber support member includes first and second sides and a flexure region between the first and second sides. The first and second sides join the fiber support member at the intersections of the flexure region with the first and second sides, respectively.

### FIELD OF THE INVENTION

The present invention relates to large core plastic optical fiber and more particularly to channeling for mounting and supporting such fiber.

### BACKGROUND

Large core plastic optical fiber, often known as light fiber, is a product used in lighting applications. Light fiber is known as large core because it has a very large diameter compared to conventional optical fibers used for communications. Light fibers generally range from about five mm to about eighteen mm in diameter. Bundles of smaller fibers are sometimes used instead of a single large fiber. Such bundles provide lower packing densities and result in greater insertion loss than single large fibers. Furthermore, extraction from bundled fibers is less efficient than from single large fibers. Therefore, single large fibers are generally preferred for lighting applications.

Light fiber has many uses both in decorative and functional lighting. Light fiber is generally broken into two categories known as end-light and side-light. End-light fibers are optimized for the efficient transportation of light with low absorption and low loss so that almost all of the light inserted into the fiber at one end emerges at or near the other end of the fiber. Side-light fiber, on the other hand, is optimized to emit light laterally along the entire length of the fiber. Preferably, side-light fiber will provide substantially uniform emission over the length of the fiber. For these purposes, generally uniform means uniform in appearance to the human eye. Over relatively long expanses, for example 20 meters or more, an intensity ratio of three to one from one end to the other will appear uniform to most people, as long as there are no abrupt changes in intensity. In addition it is possible to combine end-light and side-light fibers so that an end-light fiber emits light from its end into a side-light fiber which then provides uniform emission over a distance. Such an arrangement makes it possible to separate the actual light source from the area to be illuminated.

There are many reasons why light fiber is advantageous over conventional lighting systems. For example, it may be used in remote source lighting. In remote source lighting the actual area to be lit is physically separated from the light source. This is useful for refrigerated areas because the heat emitting light source does not need to be located inside the refrigerated area. Remote source lighting is also useful in areas where explosion is a risk because the electrical components and heat emitting components are located outside of the hazardous area. Remote source lighting is advantageous is underwater lighting as well because the electrical components may be isolated from the water. Remote source lighting is also useful for lighting areas that are difficult to reach. The light source may be placed in a convenient location to simplify maintenance, while the fiber delivers light to the more difficult to reach location.

Side-light fibers also provide advantageous replacement of other types of conventional lighting. For example, side-light fibers may be used as a mercury-free replacement for conventional fluorescent lights in a location where linear light sources are desired. Side-light fiber may also be used as a much more durable replacement for neon lights. Besides not being subject to breakage like neon lights, light fiber avoids the expense of custom glass bending and glass blowing associated with neon light fixtures. Furthermore, light fiber may be used to provide lighting effects unobtainable with neon. For example color wheels may be used to provide light fixtures having neon-like appearance while providing changing colors. By using two color wheels inserting different colors at each end of a light fiber a variety of effects may be achieved by the color mixing from the two light sources.

A variety of techniques may be used to manipulate the light distributed from light fiber. These are generally known as extraction techniques. U.S. Pat. Nos. 5,432,876, 5,659,643 and 5,845,038, the teachings of which are incorporated herein by reference, teach notching the fiber so that light is extracted from the fiber by total internal reflection from the notches. Published PCT application WO 00/25159 teaches the incorporation of various reflective materials, such as titanium dioxide, into the fiber clad in order to enhance both the extraction and the uniformity of the light emission. A light fiber according to this application is sold by Minnesota Mining and Manufacturing Company under the name HL Fiber.

Because of its flexible nature, it is necessary to support light fiber for viewing. A common way of doing so is to clamp the light fiber in a channel. FIGS. 1 and 2 illustrate a prior art channel, designated generally as 10, with a light fiber installed therein. Channel 10 is often known as a “U-channel” because its cross section approximates the shape of a letter U.

Generally U-channel 10 will be either a transparent or a white extruded polymer, although other colors may be used if desired. If U-channel 10 is transparent, light will be emitted through sides 12 and 14 as well as exposed region 20 of light fiber 18. If U-channel 10 is white, light emitted from portions of the circumference of light fiber 18 other than exposed region 20 will be reflected by U-channel 10 so that all effective emission comes through exposed region 20.

U-channels, such as U-channel 10, have numerous disadvantages. For example, if U-channel 10 is white for improved reflection, much of the light emitted around portions of the circumference of light fiber 18 other than in exposed region 20 will require multiple reflections from light U-channel 10 prior to being emitted through exposed region 20. Furthermore, dirt or other debris may collect in void areas 22 and 24. This is a disadvantage regardless of whether channel 10 is transmissive or reflective. Absorption by material in voids 22 and 24 will reduce either transmission through sides 12 and 14 in a transmissive channel or reflection by U-channel 10 in a reflective channel.

Light fiber 18 is retained in U-channel 10 by contact in contact regions 26 and 28. The relatively short distance of contact regions 26 and 28 presents problems. Temperature cycling can cause the fiber to loosen and actually pop out of U-channel 10. In order to avoid this, wires are often wrapped around U-channel 10 and light fiber 18 at spacing of approximately 25 to 60 centimeters. Such wires are aesthetically undesirable. Alternatively, or in addition to such wires, U-channel 10 and fiber 18 may be sized such that fiber 18 is tightly pinched in U-channel 10. This may distort the circumference of fiber 18 causing undesirable extraction effects and non-uniformity.

Mounting U-channel 10 on a surface such as a wall also presents problems. Since fiber 18 preferably fits tightly against bottom 16 of U-channel 10, it is difficult to use mechanical fasteners that have heads such as screws or bolts to mount U-channel 10. Adhesives applied to bottom surface 28 of U-channel 10 may be used instead of mechanical fasteners. However, the inherent stiffness of the light fiber may create sheer and peel forces that may cause U-channel 10 to separate from the surface to which it is mounted. Even when very aggressive adhesives are used, such as those used on VHB tapes available from Minnesota Mining and Manufacturing Company, a period of several hours is required for the adhesion to build sufficiently. Such delays between mounting the channel and installing the fiber are undesirable.

FIGS. 3 and 4 show another channel element, designated generally as 50, of the prior art. Channel 50 is commonly known as a “W-channel.” W-channel 50 includes a fiber support member 52, a central ridge 54, and a base 56. W-channel 50 is generally made by extrusion of a polymer material. As with U-channel 10 of FIGS. 1 and 2, W-channel 50 is generally either transparent or white, but may be any desired color.

In use, a light fiber is inserted into fiber support member 52. The generally round shape of fiber support member 52 holds a light fiber better than do sides 12 and 14 of U-channel 10. However, extrusion tolerances will often cause fiber support member 52 to be out of round leaving some gaps. As with U-channel 10, undesirable dirt and debris may accumulate in these gaps. Furthermore, the fact that fiber support member 52 is out of round can cause the pressure exerted on a light fiber by channel 50 and the contact areas between a light fiber and fiber support member 52 to vary along the length of the light fiber. Such variation can cause undesirable variations in light extraction from the light fiber.

W-channel 50 may be attached to a wall by means of an adhesive applied to bottom surface 58 of base 56. However, the same problems associated with the use of adhesives for mounting U-channel 10 apply to the use of adhesives with W-channel 50. Alternatively, mechanical fasteners such as screws, bolts, or rivets may be used to secure W-channel 50 to a wall. As shown, W-channel 50 is mounted by means of screws 60 and 62. A problem with the use of mechanical fasteners such as screws 60 and 62 is that they are visible when the channeling is mounted and produce an unpleasing aesthetic effect.

### SUMMARY OF THE INVENTION

According to one embodiment of the invention, a support channel for a light fiber includes a fiber support member designed to partially circumscribe a light fiber, first and second legs, and first and second feet at the ends of the first and second legs. The fiber support member includes first and second sides and a flexure region between the first and second sides. The first and second sides join the fiber support member at the intersections of the flexure region with the first and second sides, respectively.

According to another embodiment of the invention, a support channel for light fiber includes a fiber support member designed to partially circumscribe a light fiber and a mounting member slideably engagable with the fiber support member.

According to still another embodiment of the invention, a support channel for a light fiber includes a fiber support member wherein a portion of the circumference of the fiber support member is transparent and a portion of the circumference of the fiber support member is highly reflective.

### BRIEF DESCRIPTION OF THE DRAWINGS

FIG. 1 is a perspective view of a light fiber support channel of the prior art;

FIG. 2 is an end view of the light fiber support channel of FIG. 1;

FIG. 3 is a perspective view of another light fiber support channel of the prior art;

FIG. 4 is an end view of the light fiber support channel of FIG. 3;

FIG. 5 is a perspective view of a light fiber support channel according to the invention;

FIG. 6 is an end view of a light fiber support channel according to the invention;

FIG. 7 is a perspective view of a mounting member according to the invention;

FIG. 8 is an end view of another embodiment of a light fiber support channel according to the invention; and

FIG. 9 is a side view of a lighting apparatus according to the invention.

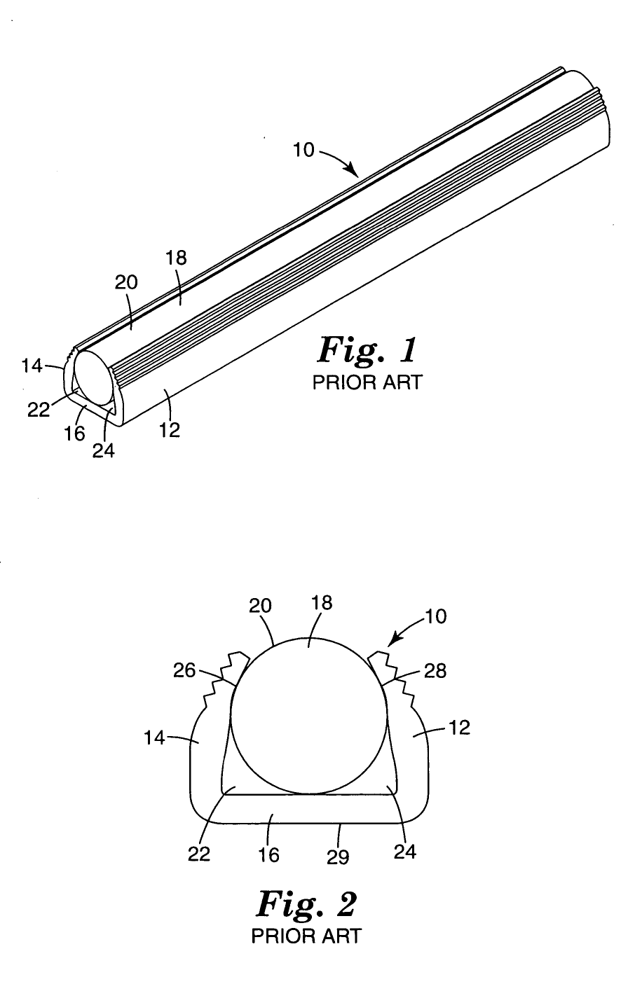

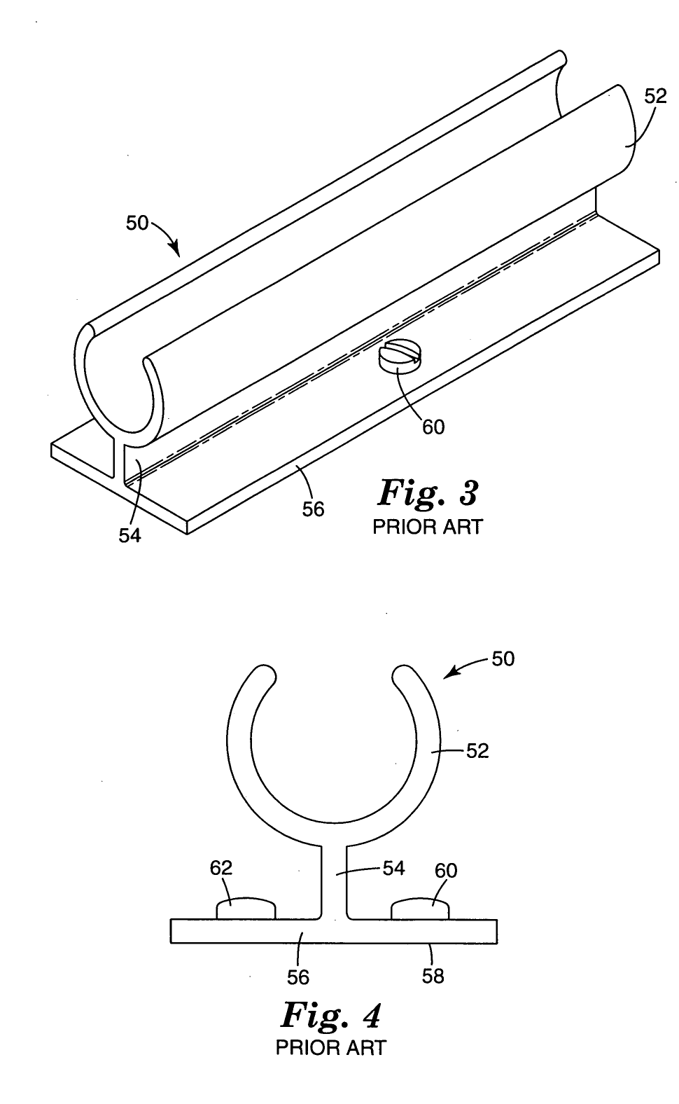

### DETAILED DESCRIPTION

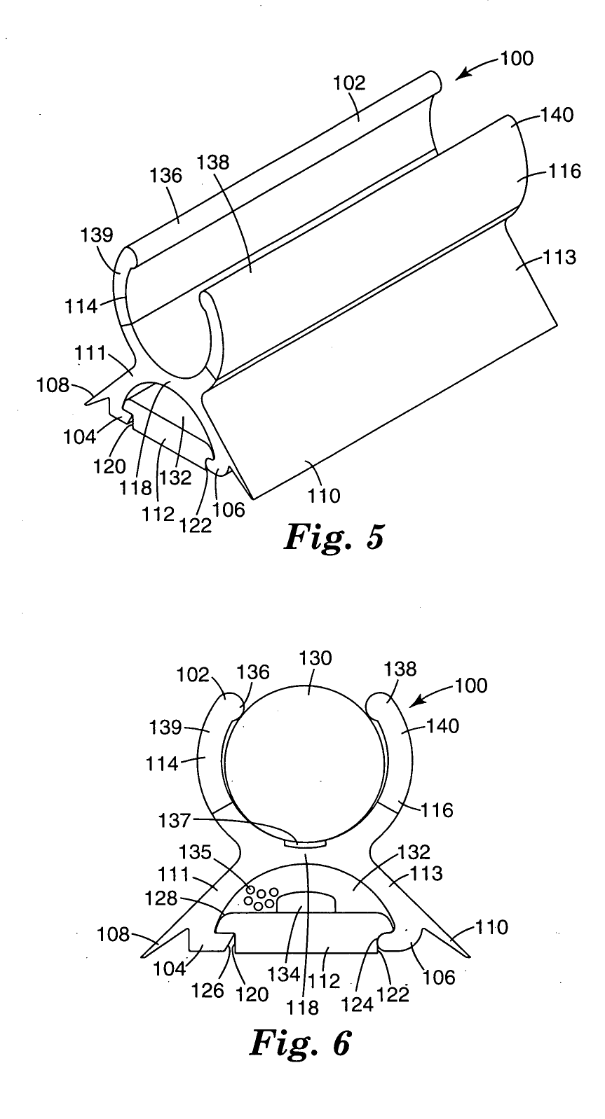

FIG. 5 is a perspective view of a channel, designated generally 100, according to the present invention and FIG. 6 is an end view of the same channel. Channel 100 includes fiber support member 102, feet 104 and 106, flashing elements 108 and 110, legs 111 and 113, and mounting member 112. In use, mounting member 112 is secured to a wall or other surface. Generally, mounting member 112 will be provided in portions approximately 2 to 4 centimeters long, although longer pieces may be used. Fiber support member 102 includes sides 114 and 116 and flexure region 118 with legs 111 and 113 joining fiber support member 102 at the intersections of sides 114 and 116 with flexure region 118. Flexure region 118 is so named because channel 100 will flex at that location when walls 114 and 116 are pressed toward one another. Generally, region 118 will be a natural flexure region, although the wall of fiber support number 102 may be made thinner in flexure region 118 in order to improve its flexibility. The actual thicknesses of walls 114 and 116 and flexure region 118 will depend on the material of which channel 100 is made.

When walls 114 and 116 are pressed toward one another and the unit flexes in flexure region 118, feet 104 and 106 will be moved further apart. When feet 104 and 106 are moved further apart, they may be snapped over mounting member 112 and into recesses 120 and 122 on the sides of mounting member 112. The pressure may then be released from sides 114 and 116 of fiber support member 102 and channel 100 will elastically spring back to its original shapeChannel 100 will then be firmly attached to mounting member 112 in a direction transverse to channel 100. Preferably, however, channel 100 is able to slide along mounting member 112 in a direction parallel to its length. Channel 100 and mounting member 112 may be said to be slideably engagable with one another. This helps eliminate stresses created by unequal thermal expansion and contraction of the various components of the system. This is particularly important if channel 100 is to be mounted outdoors in an environment where it will experience large variations of temperature.

In a preferred embodiment, as is more clearly seen in FIG. 6, foot 106 has a rounded end 124 while foot 104 has a beveled end 126 that is flat. In this way foot 106 may be inserted into recess 122 and used as a pivot. When this is done, beveled foot 104 will slide more easily over rounded edge 128 of mounting member 112 in order to snap into place. The pivoting action may be improved by providing a rounded corner in recess 122. After channel 100 has been attached to mounting member 112, a light fiber 130 is inserted into the channel where it snaps into place. Once light fiber 130 has been inserted into fiber support member 102, sides 114 and 116 are locked into place preventing fiber support member 102 from flexing in flexure region 118. Thus, light fiber 130 firmly locks channel 100 in place. When fiber 130 is in place, fiber support member 102 partially circumscribes light fiber 130. In a preferred embodiment, fiber support member 102 will circumscribe 200° to 260° of light fiber 130 and in a more preferred embodiment fiber support member 102 will circumscribe 240° of light fiber 130.

Fiber support member 102 has a shape and size determined by the shape and diameter of light fiber 130. Generally, light fiber 130 has a round cross section and the interior of fiber support member 130 will be round and have an interior diameter slightly larger than the exterior diameter of light fiber 130. However, light fiber 130 could be of any arbitrary shape, such as elliptical or in the shape of a polygon and the interior of fiber support member 102 would be a similar shape and size to accommodate light fiber 130.

Mounting member 112 may be attached to a wall or other surface in a variety of manners. It may be secured using an adhesive or an appropriate mechanical fastener such as a screw, bolt, rivet, or nail or by a combination of mechanical fasteners and adhesives. When channel 100 has been secured to mounting member 112, legs 111 and 113 and flexure region 118 define a void region 132 between channel 100 and mounting member 112. If a mechanical fastener having a head, such as head 134, is used to attach mounting member 112 to a surface, head 134 will be located in void region 132 and will not be visible to an observer. This provides a more pleasing aesthetic effect than the visible attachments of the W-channel.

Void region 132 provides another advantage. Communication connectors 135 may be run through void region 132 so that they are hidden from a viewer. Communication connectors may be wires or conventional optical fibers for data communication, but more often will be wires for providing electrical power to light sources used to insert light into light fiber 130 or for sensors. Typical data that may be sent on communication connectors 135, if they are intended for data communication, include control signals to turn a light source for light fiber 130 on or off at specified times or under specified ambient light conditions.

Flashing elements 108 and 110 extend from legs 111 and 113 and are provided to prevent dirt and other debris from interfering with feet 104 and 106 in recesses 120 and 122 and entering void region 132. Flashing elements 108 and 110 further hide feet 104 and 106, providing a more pleasing appearance. Flashing elements 108 and 110 preferably are flexible enough to follow variations in the surface to which channel 100 is mounted to0 provide a continuous, tight seal.

Fiber support member 102 preferably includes enlarged or bulbous regions 136 and 138 at the ends of sides 114 and 116. Enlarged regions 136 and 138 are sized to be thicker than sides 114 and 116 by an amount approximately equal to or slightly larger than the tolerance for out of roundness in the manufacturing process for channel 100. With the tolerances of typical manufacturing processes, enlarged regions 136 and 138 will be approximately 0.4 mm thicker, radially inward than sides 114 and 116. Enlarged regions 136 and 138 are provided to ensure good contact with fiber 130 at the ends of sides 114 and 116. This ensures that channel 100 will hold light fiber 130 with a strong, three point grip at enlarged regions 136 and 138 and flexure region 118. Each of these regions will be in tight contact with light fiber 130. Because of this three point grip and the fact that two of the points are ensured to be at the ends of sides 114 and 116, channel 100 will hold light fiber 130 more securely than prior art channels. Furthermore enlarged regions 136 and 138 ensure a tight contact between fiber support member 102 and light fiber 130 at the ends of sides 114 and 116. This prevents dirt and debris from entering the region between light fiber 130 and fiber support member 102.

Channel 100 may be manufactured by a variety of known processes, but is preferably made by profile extrusion of a polymer material. Channel 100 may be of many known polymers such as vinyls, acrylics, cellulose resins,or polyesters. Specific polymers that may be used are polyvinyl chloride, polymethyl methacrylate, and polycarbonate, or cellulose acetate butyrate. Channel 100 may be transparent or may be made opaque or translucent by incorporation of an appropriate material in a transparent polymer material. In particular, it is sometimes desirable to make channel 100 highly reflective by incorporation of a reflective material. Generally, if channel 100 is to be reflective, it is preferred that it be white to provide maximum reflectivity over the entire visible spectrum, although other colors may be chosen. In some embodiments, it may even be desirable make channel 100 highly light absorptive. Channel 100 may be made white by incorporation of a highly reflective material such as titanium dioxide into a transparent polymer material. If channel 100 is made reflective, the tight contact between fiber 130 and flexure region described above provides an additional advantage. Such tight contact will provide better reflection of light emitted by light fiber 130 on the side of flexure region 118 and thus higher performance by the system.

In an alternative embodiment, channel 100 may be transparent or any desired color and reflectivity may be provided by including a reflective material 137 in a groove provided in flexure region 118. Generally reflective material 137 will be a diffuse reflector with high reflectivity. For these purposes, high reflectivity means greater than eighty-eight percent reflective, and preferably at least ninety-two percent, and more preferably at least 96 percent reflective, and most preferably at least 98 percent reflective. An example of such a material is a fused polyolefin material such as that commercially available from E.I. du Pont de Nemours and Company under the name Tyvek. A material that works particularly well as such a reflector is porous polymer reflector more completely described in U.S. Pat. No. 5,976,686, the teachings of which are incorporated herein by reference. Another diffuse reflector that will work in this embodiment is a polyvinyl chloride film pigmented with titanium dioxide. Such a film is commercially available under the name LEF from Minnesota Mining and Manufacturing Company. Alternatively, reflective material 137 could be a specular reflector. Examples of specular reflectors that could be used are commercially available from Minnesota Mining and Manufacturing Company under the names Silverlux film and 3M ESR. 3M ESR is described in U.S. Pat. Nos. 6,117,530 and 6,210,785 and Patent Cooperation Treaty publication WO 97/01726, the teachings of which are incorporated herein by reference.

In another embodiment channel 100 may be made of co-extruded materials. In this way different portions of the circumference of fiber support member 102 may have different optical properties. For example, a portion of fiber support member 102 may be transparent and another portion may be highly reflective. As shown, outer portions 138 and 140 of sides 114 and 116 of fiber support member 102 may be of a transparent polymer material while the remainder of channel 100, i.e. the remainders of sides 114 and 116, flexure region 118, legs 111 and 113, feet 104 and 106 and flashing elements 108 and 110, may be highly reflective. These regions are co-extruded so that they form a strong unitary unit. Such co-extrusion permits light fiber 130 to emit light over a desired range of its circumference while allowing channel 100 to reflect light emitted in other directions in order to increase the efficiency of the system.

In still another embodiment, channel 100 may be made by a more complicated co-extrusion process. In such a process, outer regions 138 and 140 of sides 114 and 116 of fiber support member 102 may be of a transparent material and flexure region 118 may be of a highly reflective white material while the remainder of channel 100, i.e. the remainder of sides 114 and 116 and flashing elements 108 and 110, may be of a colored material. The color may be chosen for desired aesthetic effects.

In addition to colorants, other materials may be added to the polymer materials of which channel 100 is made. Generally, these will be protective additives chosen for the environment in which channel 100 is to be installed. Examples include uv stabilizers and fungicides.

FIG. 7 is a perspective view of a preferred embodiment of mounting member 112. Mounting member 112 may be machined of a metal such as aluminum if greater strength is desired, but typically would be injection molded or profile extruded of a polymer material. Preferably, mounting member 112 includes a hole 142 through its base 144 to accommodate a mechanical fastener. Furthermore, mounting member 112 preferably includes a concave portion 146 on the front of mounting member 146. For these purposes, concave portion 146 is said to be on the front of mounting member 112 as shown in FIG. 7, but the term front is not intended to imply any particular orientation when mounting member 112 is installed on a wall or other surface. Concave portion 146 provides two advantages. It reduces the amount of material required to make mounting member 112 and it allows void region 132 to be reduced in size while still accommodating the head of a mechanical fastener. Concave region 146 may extend to ends 148 and 150 of mounting member 112, but, if mounting member is injection molded, concave portion 146 preferably extends to positions just short of ends 148 and 150. This provides greater strength to mounting member 112.

In use, channel 100 is generally provided in lengths of approximately two meters if light fiber 130 is to be mounted in a straight line. If light fiber 130 is to be mounted in a curved pattern, shorter lengths of channel 100 may be used with the fiber curving between the sections of channel 100.

Mounting member 112 may extend the entire length of the sections of channel 100. Preferably, however, mounting member 112 is provided in two to four cm lengths. These may be attached to the surface on which light fiber 130 is to be mounted with separation intervals of 0.3 to 0.6 meters. Using shorter lengths of mounting member 112 reduces expense as well as making it easier to attach channel 100 to mounting member 112 while still providing adequate support for channel 100 and light fiber 130.

As previously described, channel 100 is preferably free to slide on mounting member 112 in order to reduce stresses caused by thermal expansion and contraction. If channel 100 is to be mounted extending vertically, however, such free movement creates a problem. Under such circumstances channel 100 will slide off of mounting member 100 unless it is held in some way. When mounted vertically, channel 100 may be held in any conventional manner such as by adhesives or by tie-downs. Alternatively a screw or other mechanical fastener could be inserted through flashing element 108 or 110. In preferred embodiments, however, a channel holding or retaining element is provided in void region 132. In this way the holding element may prevent undesirable movement of channel 100 along mounting member 112 while not detracting from the appearance of the installation.

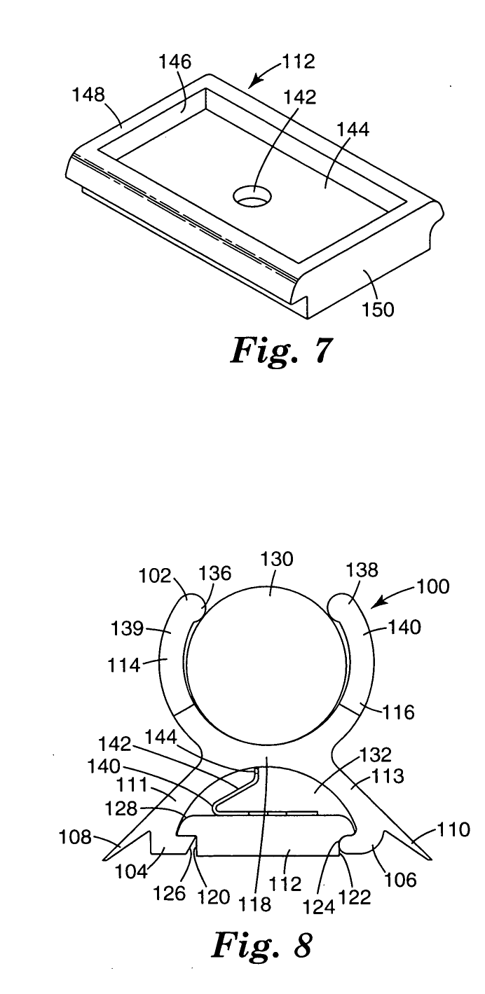

A preferred system for holding channel 100 in place on mounting member 112 is shown in FIG. 8. According to the embodiment of FIG. 8, a channel holding element 140 is provided in void region 132. Channel holding element 140 includes an arm 142 extending from mounting member 112. Arm 142, in turn, includes a peak 144. Arm 142 acts as a spring that forces peak 144 into contact with channel 100. Peak 144 should be sharp enough that, when channel 100 is snapped onto mounting member 112, it will penetrate channel 100 sufficiently to hold channel 100 in place in a direction parallel to channel 100 with respect to mounting member 112. Alternatively, peak 144 could simply provide sufficient frictional force through its contact with channel 100 to hold channel 100 in place.

Channel holding element 140 may be unitary with mounting member 112, but is preferably a separate piece. If channel holding element 140 is a separate piece it may be held place with the same mechanical fastener that is used to attach mounting member 112 to the supporting surface. Materials of which channel holding element 140 may be made include steel, stainless steel, aluminum, polymer coated metals, and plastics. A typical, vertical installation of light fiber 130 using channel 100 should include enough channel holding elements to hold channel 100 and light fiber 130 in place without unduly restricting the ability of channel 100 to slide on mounting member 112 to reduce stress due to thermal cycling. In a preferred embodiment, one channel holding element near the center of each piece of channel 100 is used to hold channel 100 and light fiber 130 in place while still permitting both ends to be slideably engaged with mounting member 112 and to move freely with changes in temperature.

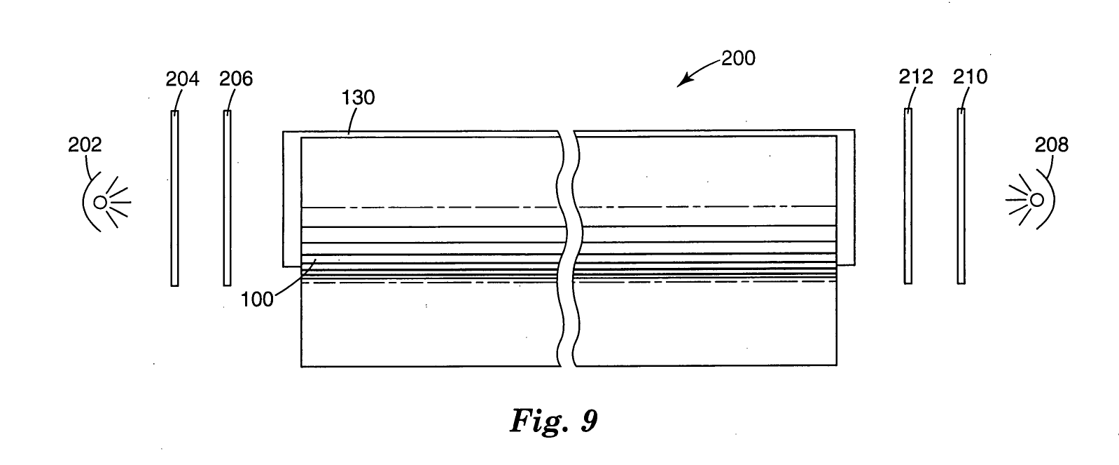

FIG. 9 is a side view of a lighting apparatus, designated generally as 200, according the present invention. Lighting apparatus 200 includes channel 100, light fiber 130 and a light source 202. Light source 202 is positioned to insert light into a first end of light fiber 130. Light source 202 could be any light source suitable for inserting light into a light fiber. Examples of light sources that may be used include metal halide and halogen lamps. In some installations an array of one or more high output light emitting diodes may be used. Light emitting diodes provide the advantage of very high efficiency.

Also included in lighting apparatus 200 is an optional color filter 204. Color filter 204 can be any conventional material to provide a light emitted by light source 202 with a desired color. Color filter 204 could also be a color wheel or other variable color filter to provide desired effects. In addition to or instead of color filter 204, an optional douser 206 may be provided. Douser 206 is particularly useful in decorative lighting if light source 202 is of a type that requires a substantial period of time to reach full brightness. Lighting apparatus 200 also includes an optional second light source 208, positioned to insert light into a second end of light fiber 130, an optional second color filter 210, and a second optional douser 212. As with light source 202 and color filter 204, light source 208 and color filter 210 could be any light source and color filter that may be used with light fiber.

What is claimed is:

1. A support channel for light fiber said channel comprising:
a fiber support member said fiber support member being designed to partially circumscribe a light fiber;
a mounting member slideably engagable with said fiber support member.

2. The support channel for light fiber of claim 1 further comprising a channel holding element that restricts movement of said fiber support member with respect to said mounting member.

3. The support channel for light fiber as described in claim 1 wherein said fiber support member sides have ends that are enlarged radially inward.

4. The support channel for light fiber as described in claim 3 wherein said fiber support member has a manufacturing tolerance and said ends of fiber support member sides are enlarged radially inward by an amount approximately equal to said manufacturing tolerance.

5. The support channel for light fiber as described in claim 3 wherein said fiber support member has a manufacturing tolerance and said ends of fiber support member sides are enlarged by an amount greater than said manufacturing tolerance.

6. The support channel for light fiber as described in claim 3 wherein said enlarged ends of said fiber support member are enlarged by approximately 0.4 mm.

7. The support channel for light fiber as described in claim 1 wherein said channel is of an extruded polymer material.

8. The support channel for light fiber as described in claim 7 wherein said channel is of a material selected from the group consisting of vinyl resins, cellulose resins, acrylic resins, and polycarbonate.

9. The support channel for light fiber as described in claim 7 wherein said channel also includes a protective additive.

10. The support channel for light fiber as described in claim 9 wherein said protective additive is an uv stabilizer.

11. The support channel for light fiber as described in claim 1 wherein said channel is white and highly reflective of light.

12. The support channel for light fiber as described in claim 1 wherein said channel is transparent.

13. A support channel for light fiber having a fiber support member said fiber support member being designed to partially circumscribe a light fiber, said fiber support member having a circumference wherein a portion of said circumference is transparent and a portion of said circumference is highly reflective of light.

14. The support channel for light fiber as described in claim 13 wherein said fiber support member sides have ends that are enlarged radially inward.

15. The support channel for light fiber as described in claim 14 wherein said fiber support member has a manufacturing tolerance and said ends of fiber support member sides are enlarged radially inward by an amount approximately equal to said manufacturing tolerance.

16. The support channel for light fiber as described in claim 14 wherein said fiber support member has a manufacturing tolerance and said ends of fiber support member sides are enlarged by an amount greater than said manufacturing tolerance.

17. The support channel for light fiber as described in claim 14 wherein said enlarged ends of said fiber support member are enlarged by approximately 0.4 mm.

18. The support channel for light fiber as described in claim 13 wherein said channel is of an extruded polymer material.

19. The support channel for light fiber as described in claim 18 wherein said channel is of a material selected from the group consisting of vinyl resins, cellulose resins, acrylic resins, and polycarbonate.

20. The support channel for light fiber as described in claim 19 wherein said channel also includes a protective additive.

21. The support channel for light fiber as described in claim 20 wherein said protective additive is an uv stabilizer.
